(19) United States
(12) Patent Application Publication
(10) Pub. No.: US 2023/0201645 A1
(43) Pub. Date: Jun. 29, 2023

(54) COOLANT INJECTION NOZZLE FOR FIRE SUPPRESSION

(71) Applicants: Marvin Cain, SR., Patterson, CA (US); Moses Cain, III, Hayward, CA (US)

(72) Inventors: Marvin Cain, SR., Patterson, CA (US); Moses Cain, III, Hayward, CA (US)

(21) Appl. No.: 18/069,214

(22) Filed: Dec. 20, 2022

Related U.S. Application Data
(60) Provisional application No. 63/293,713, filed on Dec. 24, 2021.

(51) Int. Cl. A62C 31/02; A62C 99/00; A62C 5/00

(52) U.S. Cl. CPC A62C 31/02; A62C 5/002; A62C 99/0072

(57) ABSTRACT

A fire suppression system includes a Coolant Infusion Spray Nozzle (CISN) and a Coolant Introduction Adapter Cap (CIAC). The CISN includes a water inlet and a coolant inlet. The CISN also includes a coolant infuser with infusion aperture(s) for injecting coolant into the water as it is bypassing the coolant infuser. This CISN generates a fire suppressing stream of coolant and water mixture. The CIAC supplies water and coolant to the CISN. The CIAC is coupled to a water source, and is also coupled to the CISN via hoses. The CIAC can includes an elbow for directing coolant toward the CISN.

### CROSS REFERENCE TO RELATED APPLICATIONS

This application claims the benefit and is a non-provisional of U.S. Provisional Application No. 63/293,713 filed Dec. 24, 2021 entitled “Coolant Injection Nozzle for Fire Suppression”, which application is incorporated in its entirety by this reference.

### BACKGROUND

The present invention relates to efficient systems and methods for fire suppression using water together with a coolant.

Most traditional firefighting equipment is primarily based on water, because water is more readily available, non-polluting, and relatively inexpensive. Generally, the effectiveness of a fire suppressing stream of water depends on several physics’ principles, including the specific heat of water and the latent heat of evaporation of water. In other words, the rate and amount of heat removed from the target is determined by the volume and the ambient temperature of the fire suppressing stream of water.

The primary object of fire suppression is to remove heat as fast as possible from the target and/or to starve the target of its oxygen supply. If heat is removed faster than the target on fire can generate, then the temperature can be reduced below the temperature at which combustion can continue (flashpoint), i.e., try to extinguish the fire before the fuel is exhausted. In other words, the flashpoint is the lowest temperature at which something will burn. In the case of wood that temperature is about 600° F., noting that moisture inside the wood is also a factor.

In sum, the fire suppression effectiveness of a specific volume of water is highly dependent on the temperature of the water, which in turn is also dependent on the ambient temperature. In the hot summer months when most wildfires occur, this is a very significant issue.

It is therefore apparent that an urgent need exists for substantially enhancing the effectiveness of a given volume of water as a fire suppressor. Such improvements will enable firefighters to more quickly and effectively extinguish fires.

### SUMMARY

To achieve the foregoing and in accordance with the present invention, systems and methods for fire suppression using water with a coolant is provided. In particular these systems and methods includes the introduction of a coolant infuser and a coolant introduction adapter.

In one embodiment, a fire suppression system, configured to provide a mixture of coolant and water, includes a Coolant Infusion Spray Nozzle (“CISN”) assembly. The CISN assembly includes a water inlet for receiving water from a water source and a coolant inlet for receiving coolant from a coolant source. The CISN assembly also includes a coolant infuser with one or more infusion apertures designed to infuse the coolant into the water while the water is bypassing the exterior of the coolant infuser. This CISN assembly generates a stream of pressurized coolant and water mixture capable of effectively and quickly suppressing a fire.

In some embodiments, the fire suppression system also includes a Coolant Introduction Adapter Cap (“CIAC”) assembly, configured to supply the water and the coolant to the CISN assembly. The CIAC assembly includes a housing with a first interface and a second interface. The first interface couples the CIAC assembly to a water source, while the second interface couples the CIAC assembly to the CISN assembly via hoses. The CIAC also includes a coolant elbow for directing the coolant from a coolant source toward the CISN assembly.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A-1B are perspective views illustrating deployments of a portable embodiment of a Coolant Infusion Spray Nozzle (“CISN”) coupled to a Coolant Introduction Adapter Cap (“CIAC”) via a fire suppression hose, in accordance with the present invention;

FIG. 2 is a perspective view illustrating deployment of a vehicular-based embodiment of the CISN of FIG. 1A;

FIG. 3 is a cross-sectional view illustrating the CISN and CIAC of FIG. 1A;

FIGS. 4A-4C are perspective, front and cross-sectional views of the CISN of FIG. 1A;

FIGS. 5A-5E illustrate various components of the CISN of FIG. 1A;

FIGS. 6A-6C depict an exemplary inlet cap for the CISN of FIG. 1A;

FIGS. 7A-7B depict exemplary nozzle positioning tab, coolant infusion nozzle, coolant nozzle reducer and coolant pipe for the CISN of FIG. 1A;

FIGS. 8A-8C depict the coolant infusion nozzle for the CISN of FIG. 1A;

FIGS. 9A-9B depict the nozzle positioning tab for the CISN of FIG. 1A;

FIGS. 10A-10B depict an exemplary coolant spray head for the CISN of FIG. 1A;

FIGS. 11A-11C are perspective, side and cross-sectional views of the CIAC of FIG. 1A;

FIGS. 12A-12D depict an exemplary coolant elbow for the CIAC of FIG. 1A;

FIG. 13 is a cross-sectional view illustrating coolant injection into the water flow for the CISN of FIG. 1A;

FIG. 14 is a perspective view illustrating deployment of another vehicular-based embodiment of the CISN of FIG. 1A; and

FIGS. 15A-15C illustrate deployment of an aircraft-based embodiment of the CISN of FIG. 1A.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for substantially enhancing the effectiveness of water as a fire suppressor, by infusing a coolant into the water stream.

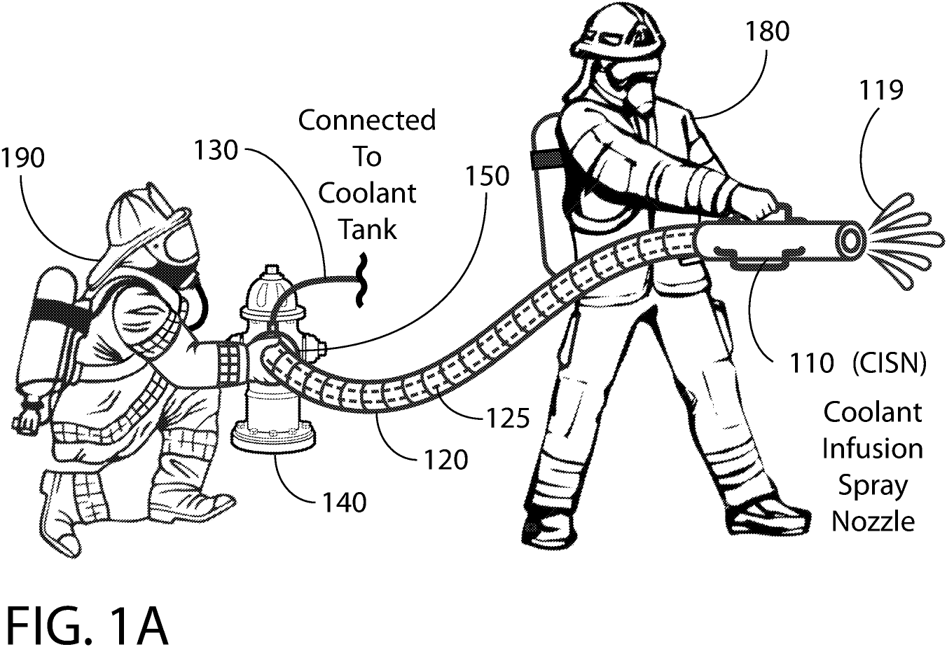

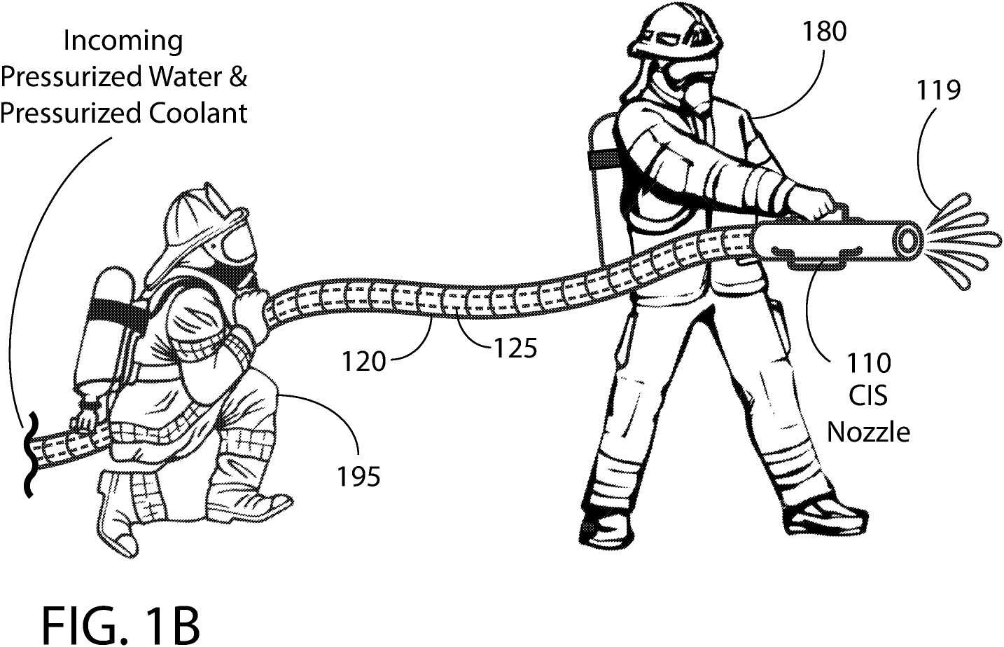

To facilitate discussion, perspective view FIG. 1A illustrates deployment of an exemplary portable Coolant Infusion Spray Nozzle (“CISN”) assembly 110 coupled to an exemplary Coolant Introduction Adapter Cap (“CIAC”) assembly 150 via a fire suppression hose 120, in accordance with one embodiment of the present invention.

In this embodiment, the CIAC assembly 150 is operatively coupled to a fire hydrant 140. A supply coolant hose 130 couples the CIAC assembly 150 to a coolant supply source (not shown) and provides coolant destined for the CISN assembly 110. Note that an inner (smaller diameter) coolant hose 125, located inside fire suppression hose 120, supplies coolant from the CIAC assembly 150 to the CISN assembly 110. Suitable coolants include liquified inert gases such as liquid nitrogen, argon and carbon dioxide.

In this exemplary deployment, a primary firefighter 180 grips one or more handle(s) of the CISN assembly 110 to direct a mixed stream of water and coolant 119 at a target object (not shown). A safety firefighter 190 is tasked with controlling the flow rate of the coolant, using, for example, one or more valves (not shown).

FIG. 1B illustrates another deployment of a firefighting team, with an additional firefighter 195 playing the role of an extra safety officer assisting the primary fighter 180. In this deployment, the additional firefighter 195, located close to the primary firefighter 180, is able to assist the primary firefighter 180 control the water hose 120 by absorbing some of the nozzle back forces, especially the nozzle recoil forces during opening and closing of the water supply valve (not shown).

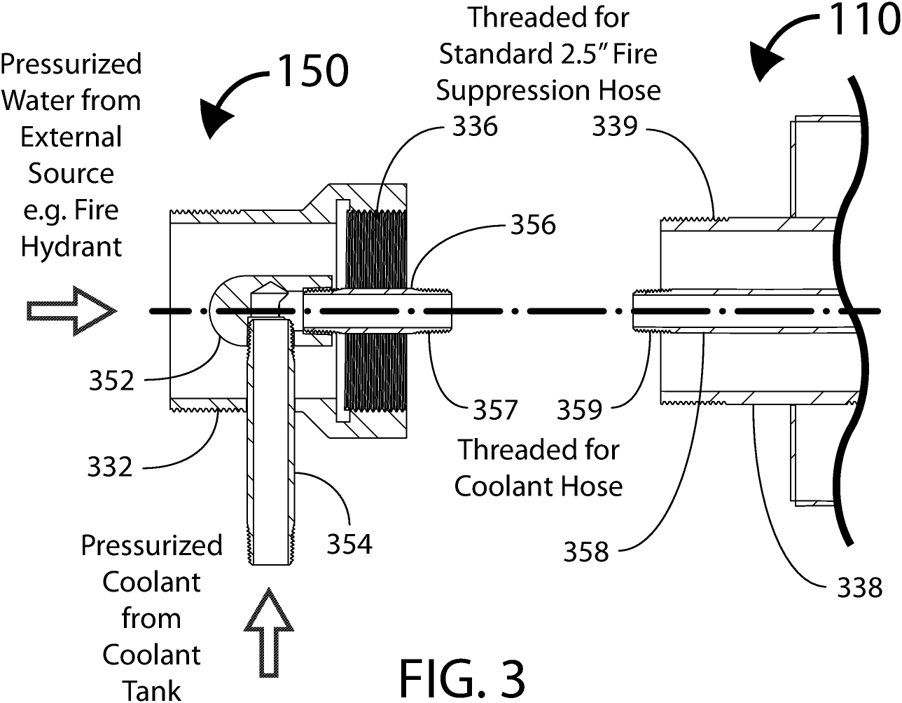

FIG. 3 is a cross-sectional view illustrating the interoperation of CISN assembly 110 with CIAC assembly 150 and depicts the respective threaded sections for interfacing with an intercoupling inner coolant hose (see hose 125 of FIG. 1A) housed within an intercoupling outer fire suppression hose (see hose 120 of FIG. 1A).

In this example, threaded section 359 of a coolant inlet, e.g., pipe 358, is intended to be inline with and operatively coupled to threaded section 357 of a coolant supply pipe 356 via inner coolant hose 125, while threaded section 336 of CIAC assembly 150 is intended to be inline with and operatively coupled to threaded section 339 of a water inlet, e.g., pipe 338, via fire suppression hose 120. Also shown is a coolant elbow 352 operatively coupling coolant supply pipe 356 to a coolant tank feed pipe 354.

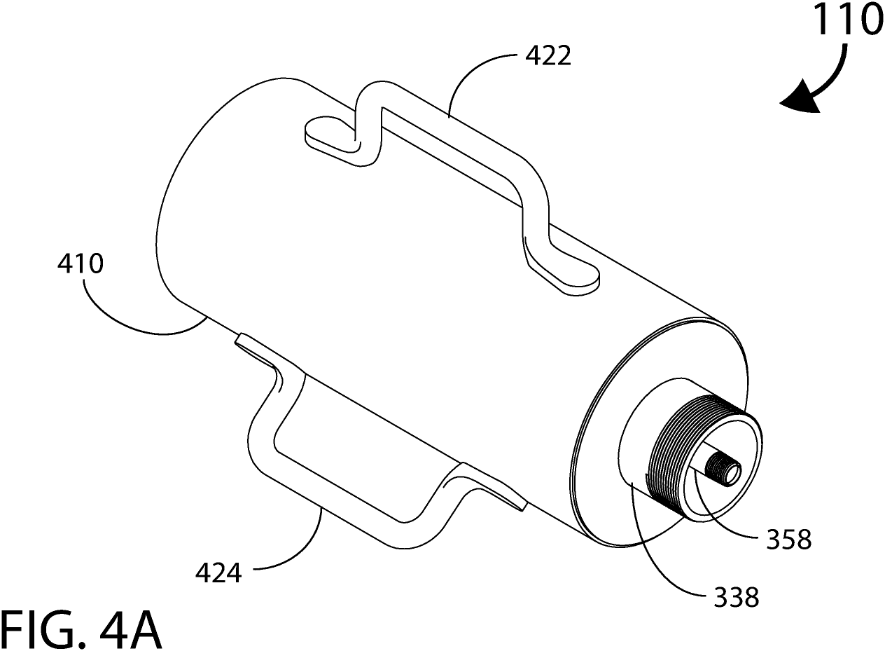

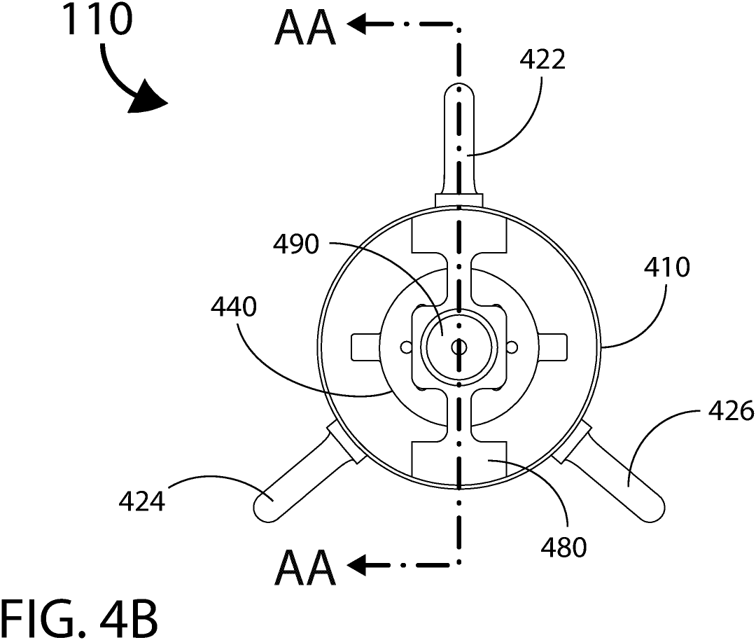

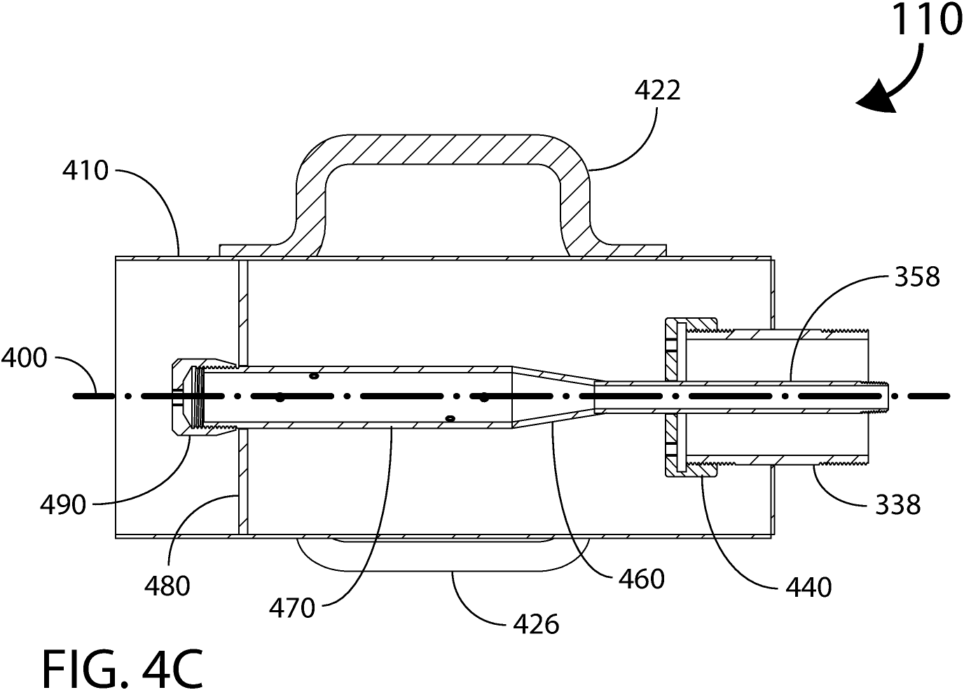

Referring now to FIGS. 4A-4C are a perspective view, a front view and a cross-sectional view AA-AA, respectively, of the CISN assembly 110 which includes a nozzle housing 410, the water inlet pipe 338, an inlet cap 440, the coolant inlet pipe 358, a coolant nozzle reducer 460, a coolant infusion nozzle 470, a nozzle positioning tab 480 and a coolant spray head 490.

In this embodiment, during manufacture, the water inlet pipe 338, the coolant nozzle reducer 460 and the coolant infusion nozzle 470 are permanently secured to each other, and are arranged inline relative to each other along central axis 400. In addition, the coolant infusion nozzle 470 is aligned to and secured inside housing 410 by the nozzle positioning tab 480. Inlet cap 440 is securely screwed onto one end of the water inlet pipe 338, and likewise coolant spray head 490 is securely screwed onto one end of the coolant infusion nozzle 470.

In some embodiments, housing 410 is coupled to one or more external handles, e.g., handles 422, 424, 426, as depicted by FIGS. 4A and 4B. In this embodiment, these three handles 422, 424, 426 are distributed 120 degrees relative their respective adjacent handles thereby also enabling two adjacent handles to also function as stabilizing legs whenever the CISN assembly 110 is placed on a substantially horizontal surface.

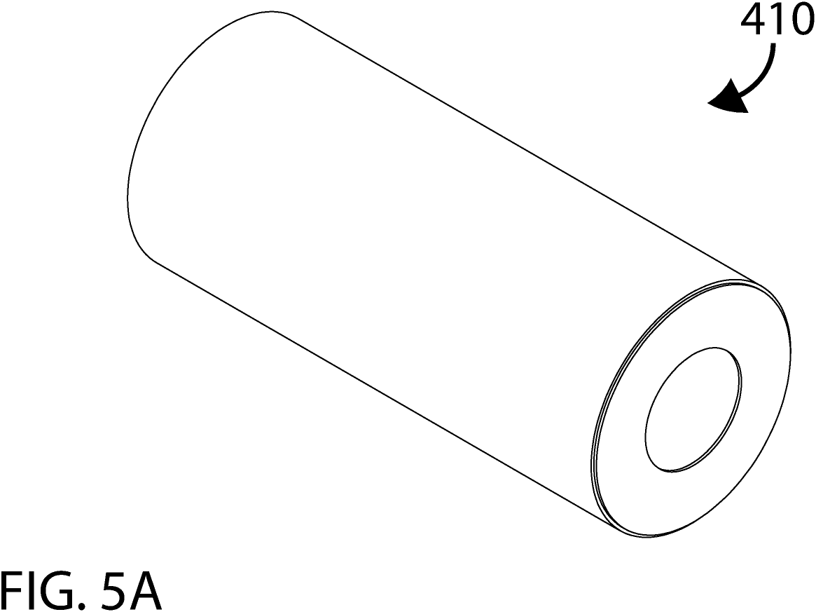

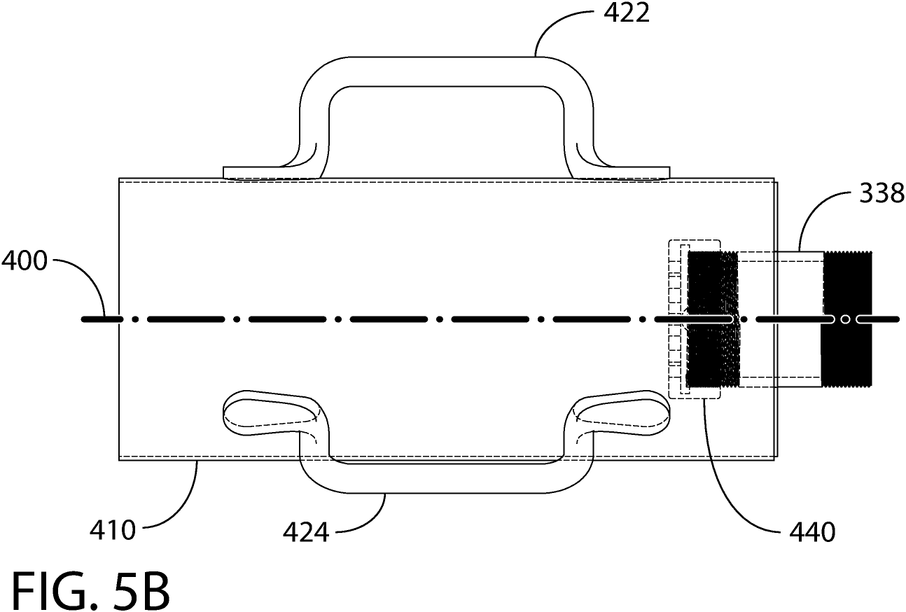

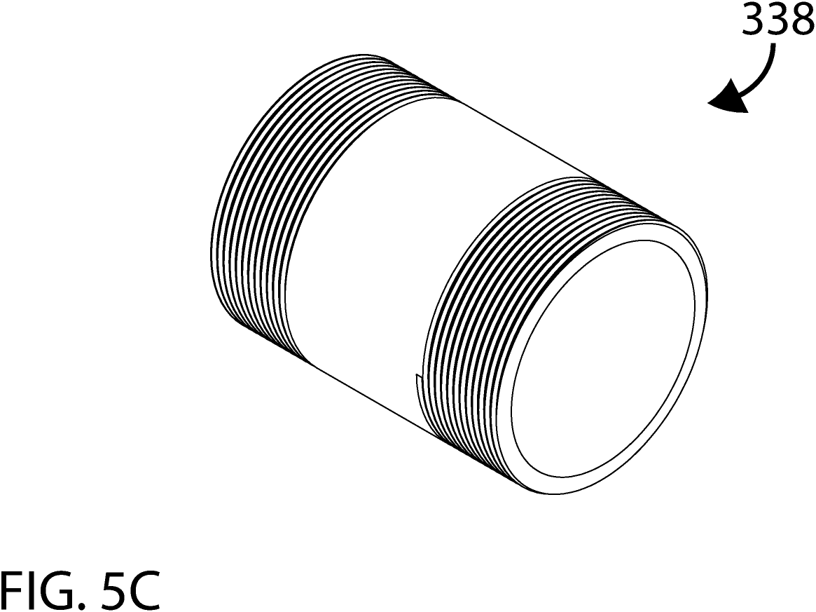

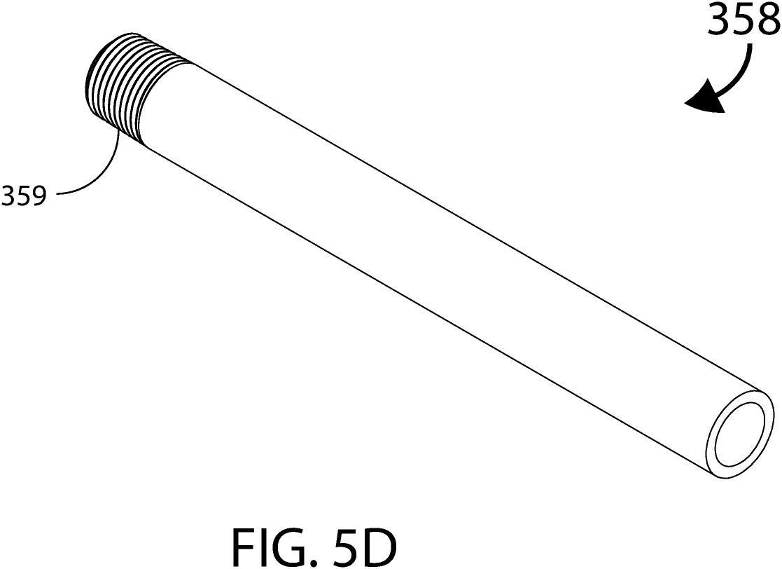

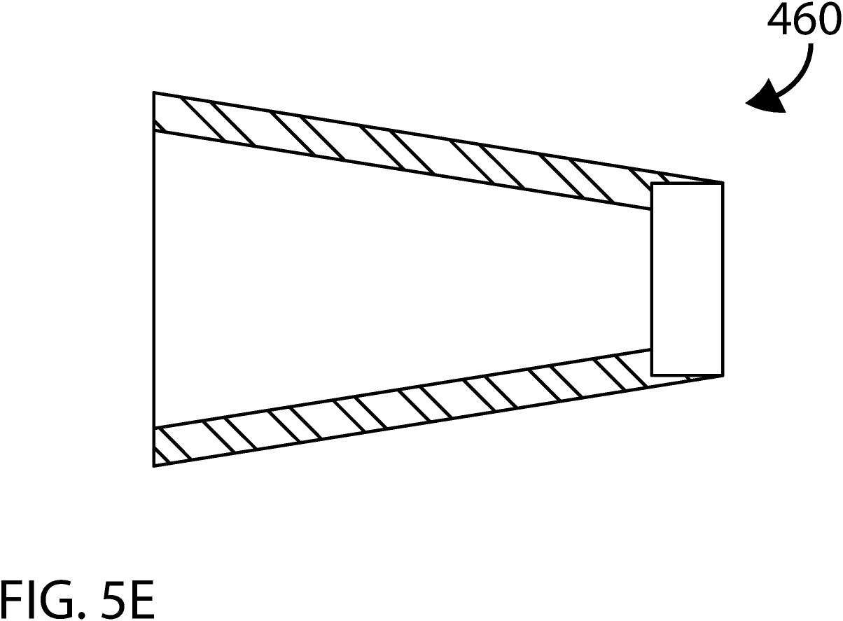

FIGS. 5A-5E provide additional views of the components of CISN assembly 110. For example, FIG. 5A depicts a perspective view of the nozzle housing 410, while FIG. 5B depicts a cross-sectional view of nozzle housing 410 together with handles 422, 424, and with the inlet cap 440 coupled to the water inlet pipe 338. In addition, FIGS. 5C, 5D and 5E show an enlarged perspective view of the water inlet pipe 338, an enlarged perspective view of the coolant inlet pipe 358, and a cross-sectional view of the coolant nozzle reducer 460, respectively.

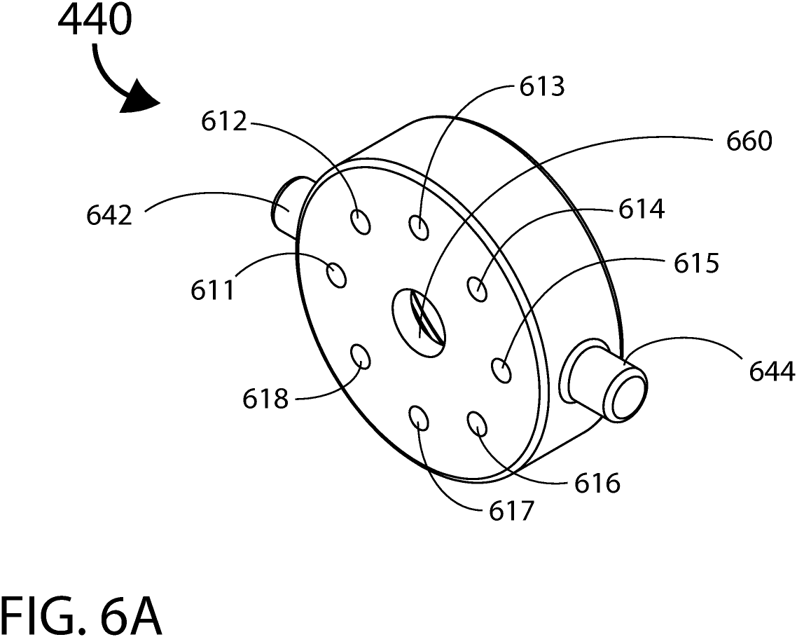

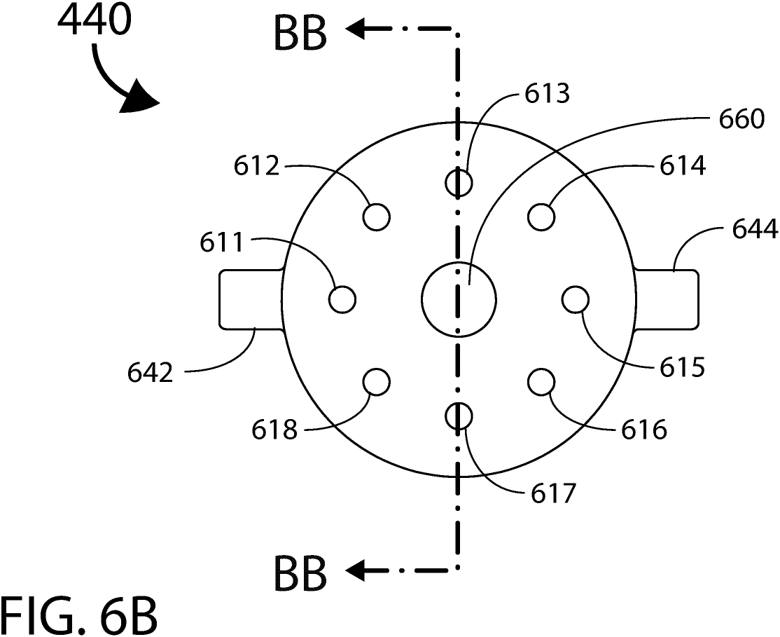

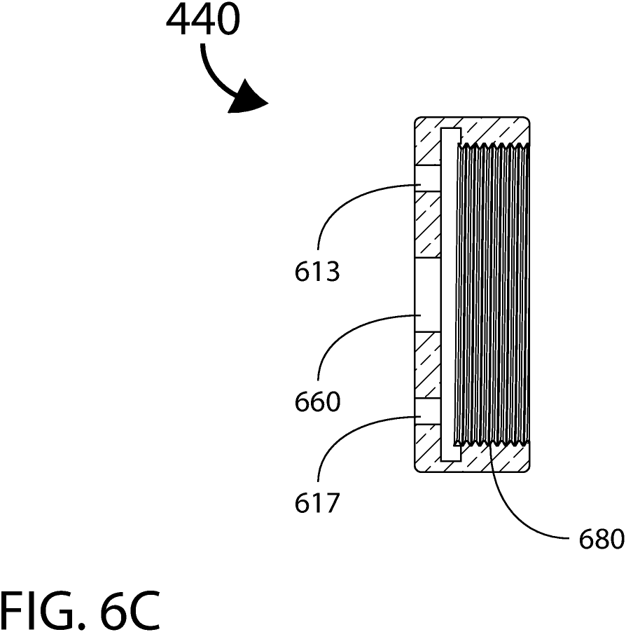

FIGS. 6A-6C depict a perspective view, a front view and a cross-sectional view BB-BB, respectively, of the inlet cap 440 of the CISN assembly 110. In this embodiment, inlet cap 440 includes a plurality of concentric water ejection holes 611, 612 , 613, 614, 615, 616, 617, 618, arranged in a radial pattern around a central water ejection 660. The diameter of the water ejection holes can be between 0.2 inches and 0.3 inches, e.g., 0.25 inches. Inlet cap 440 also includes a couple of opposing knobs 642, 644 configured to provide mechanical leverage when tightening or loosening the internal threads 680 of inlet cap 440 with respect to the water inlet pipe 338 (see also FIG. 5B).

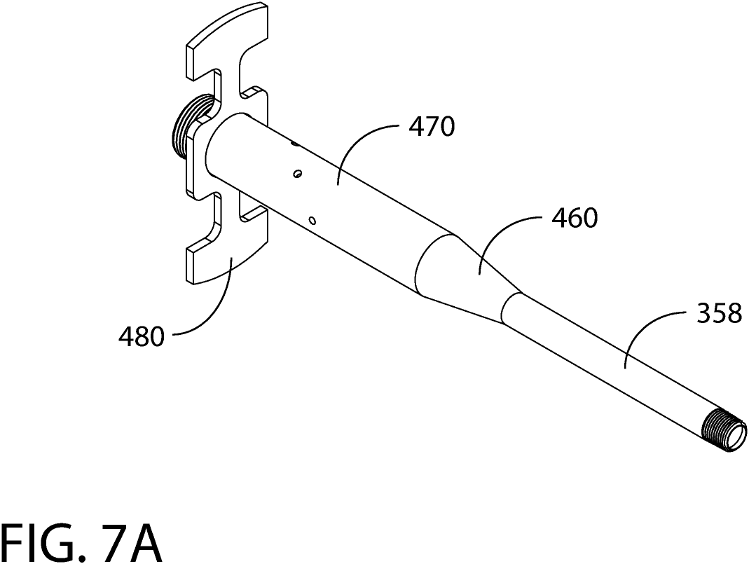

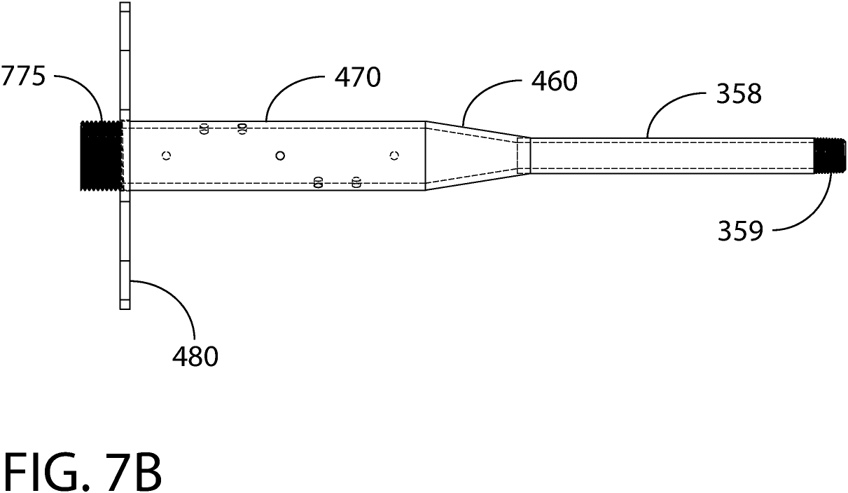

As discussed above and as shown in greater detail, FIGS. 7A-7B are perspective and side views depicting the nozzle positioning tab 480, the coolant infusion nozzle 470, the coolant nozzle reducer 460 and the coolant inlet pipe 358 for the CISN assembly 110. Note that the coolant infusion nozzle 470 includes a threaded forward-facing section 775 configured to be secured to the coolant spray head 490. In this embodiment, the coolant infusion nozzle 470, the coolant nozzle reducer 460 and the coolant inlet pipe 358 are secured to each other using one or more suitable joining techniques, including welding, brazing, adhesive, and/or screw threads.

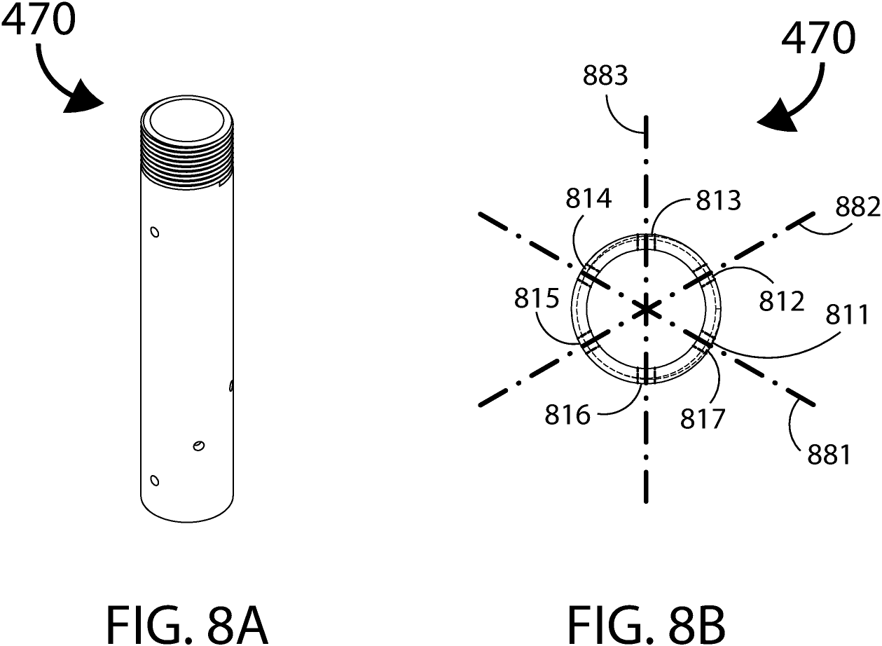

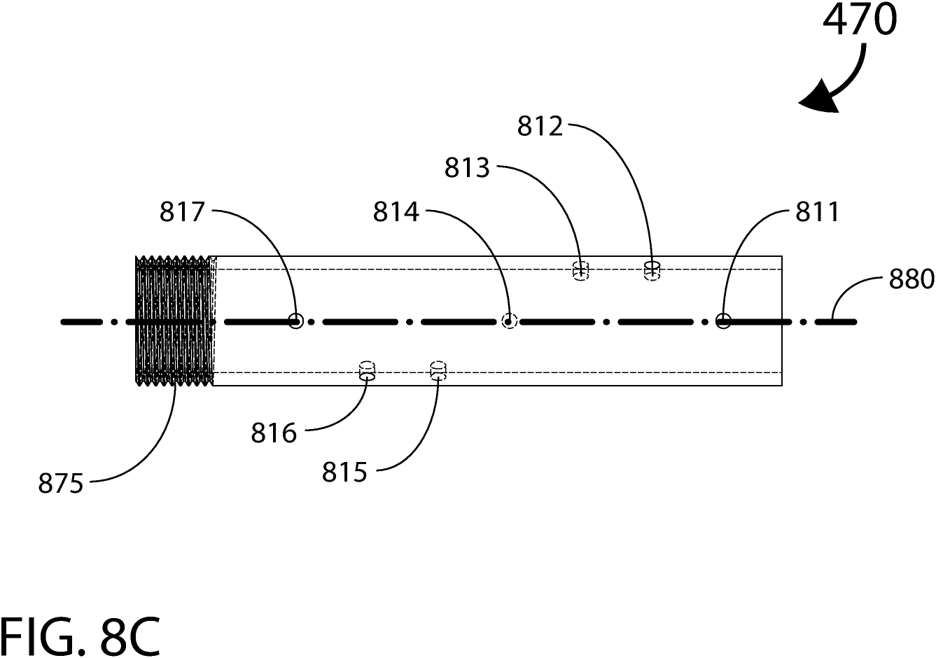

FIGS. 8A-8C are a perspective view, a front view, and a side view, respectively, depicting the exemplary coolant infusion nozzle 470 for the CISN assembly 110. In this embodiment, nozzle 470 includes a spiral series of coolant infusion apertures 811, 812, 813, 814, 815, 816 & 817, arranged symmetrically along three axis 881, 882, & 883 dissecting nozzle 470. The diameter of coolant infusion apertures 811 ... 817 can be between 0.05 inch and 0.20 inch, e.g., a diameter of 0.15 inch.

For example, as shown in FIGS. 8C and 8B, these holes 811, 812, 813, 814, 815, 816 & 817 are substantially evenly distributed along a horizontal central axis 880 and also radially, e.g., at 60 degrees from their adjacent holes, with the first hole 811 and the last hole 817 aligned with respect to each other along axis 881. Many other variations and permutations of infusion hole arrangements are contemplated without substantially deviating from the objectives of the present invention.

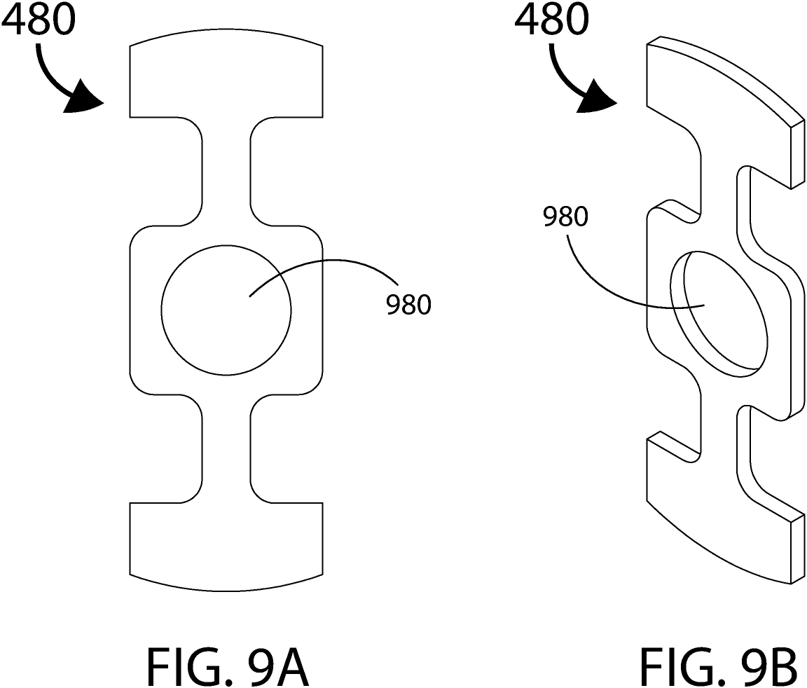

FIGS. 9A-9B are front and perspective views illustrating the nozzle positioning tab 480 for the CISN assembly 110. Referring also to FIGS. 7A-7B, in this embodiment, positioning tab 480 includes a through hole 980 configured to receive the threaded portion 775 of the coolant infusion nozzle 470, during construction of the CISN assembly 110.

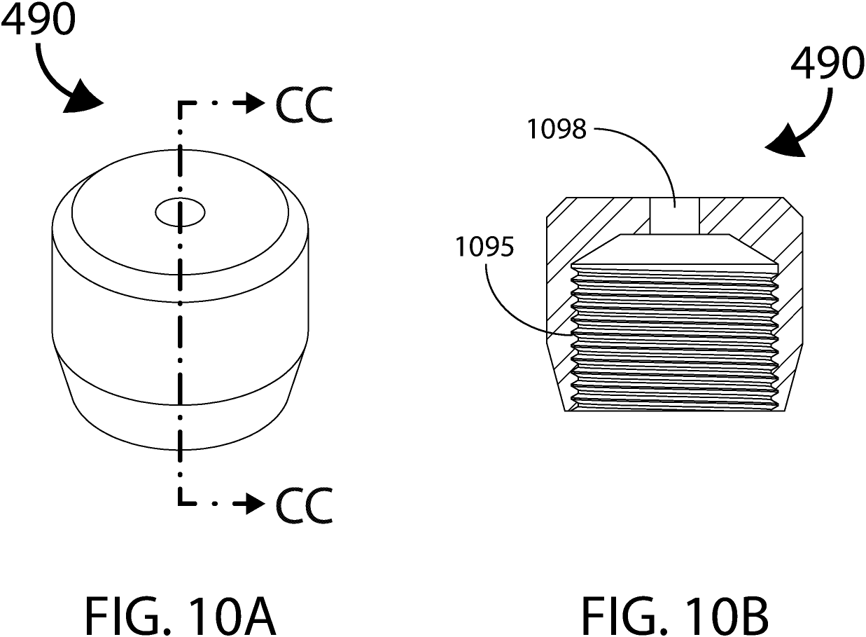

In some embodiments, as depicted in FIGS. 10A and 10B, a perspective view and a cross-sectional view CC-CC, the coolant spray head 490 of CISN assembly 110 also includes a coolant ejection hole 1098 aligned with central horizontal axis 400 (see also FIG. 4). The diameter of coolant ejection hole 1098 can be between 0.2 inches and 0.4 inches, e.g., 0.31 inches. Spray head also includes internal threads 1095 for engaging with threaded end 775 of coolant infusion nozzle 470 as depicted in FIG. 7B.

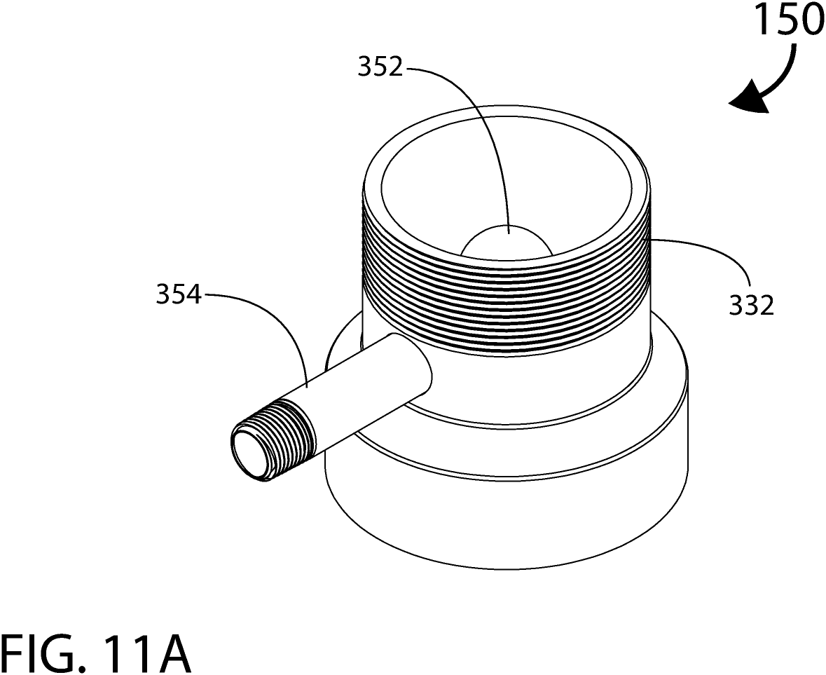

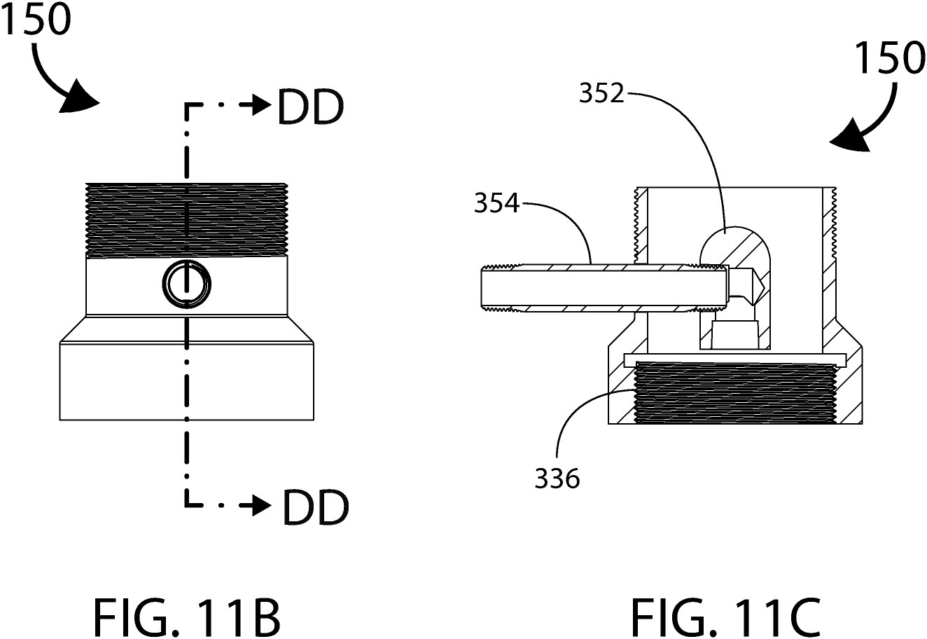

Referring back to the cross-sectional view of FIG. 3 and also FIGS. 11A-11C, an enlarged perspective view, a side view and a cross-sectional view DD-DD of an exemplary embodiment of the CIAC assembly 150, the functionality of each component of CIAC assembly 150 are now described in greater detail. In this embodiment, the external threads 332 of CIAC assembly 150 are configured to be coupled to a water source, such as fire hydrant 140 of FIG. 1A.

As discussed above, in this exemplary deployment depicted by FIG. 1A, the coolant tank feed pipe 354 is configured to be coupled the coolant elbow 352 in order to be able to provide a consistent supply of coolant from an external coolant tank (not shown) to coolant supply pipe 356, which in turn provides the coolant to the CISN assembly 110 being hand held by firefighter 180.

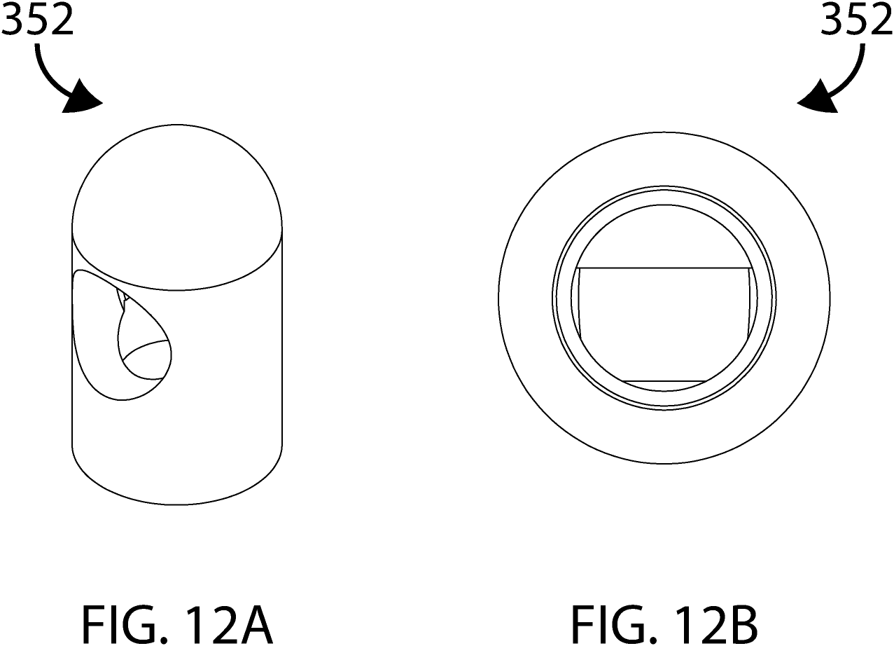

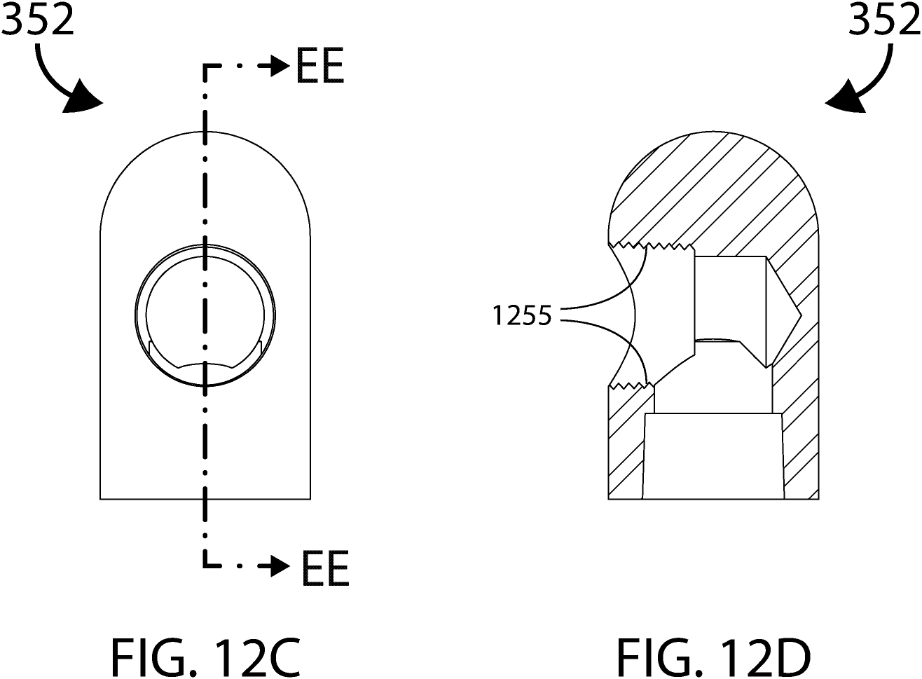

FIGS. 12A, 12B, 12C and 12D are a perspective view, a bottom view, a side view and a cross-sectional view EE-EE, respectively, depicting the coolant elbow 352 for the CIAC assembly 150 in greater detail. As shown in FIG. 12D, coolant elbow 352 includes internal threads 1255 configured to engage one end of the coolant tank feed pipe 354 depicted in FIG. 3.

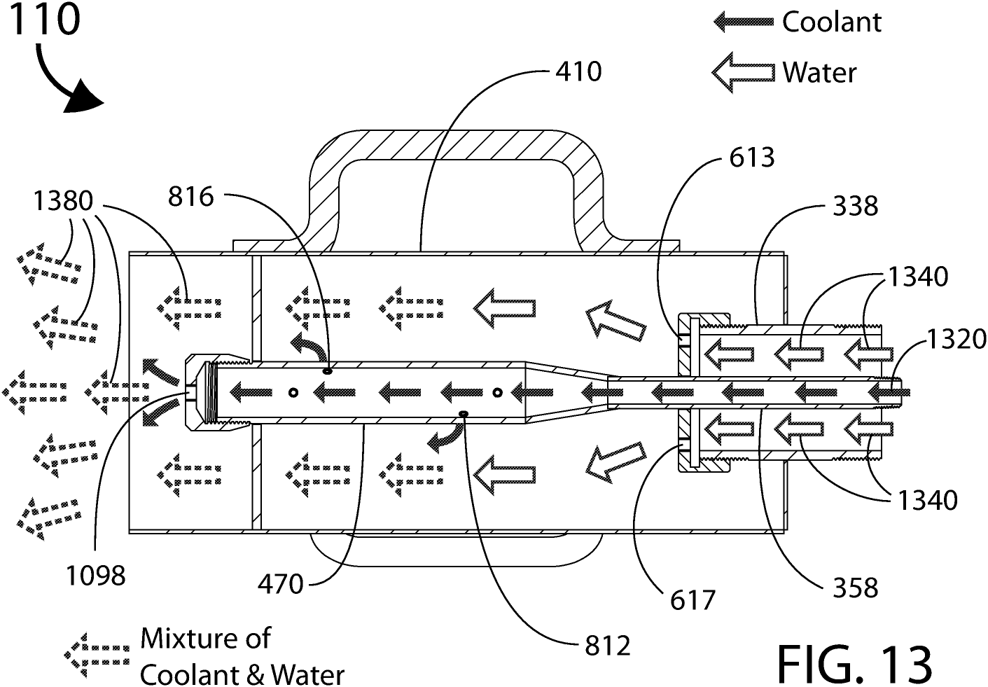

Referring also back to FIG. 4C, FIG. 13 is a cross-sectional view illustrating the infusion of a suitable coolant into the water flow for the CISN assembly 110. From right to left, water 1340 is introduced under pressure (ideally between 18-22 pounds per square inch (psi), e.g., 20 psi) into the water inlet pipe 338 from a suitable water source (not shown), such as a fire engine or a fire hydrant. In turn, the water is then introduced into a mixing chamber 1110, as defined by the interior of nozzle housing 410, via the concentric plurality of water ejection holes including holes 613 & 617.

In this embodiment, coolant 1320 is also introduced simultaneously under pressure (ideally between 375-425 psi, e.g., 400 psi) from a suitable coolant source (not shown) into coolant inlet pipe 358, and then into coolant nozzle reducer 460. Next, the coolant is introduced into coolant infusion nozzle 470, where it can be infused under pressure into the water in the mixing chamber 1110 via a plurality of coolant infusion holes 811, 812, 813, 814, 815, 816, 817 arranged in a spiral, like the steps of a spiral stairway.

In some embodiments, the resulting mixture 1380 of water and coolant is expelled from the mixing chamber 1110 and is also joined by a jet of coolant sprayed from the infusion nozzle 470 via the coolant ejection hole 1098 of coolant spray head 490.

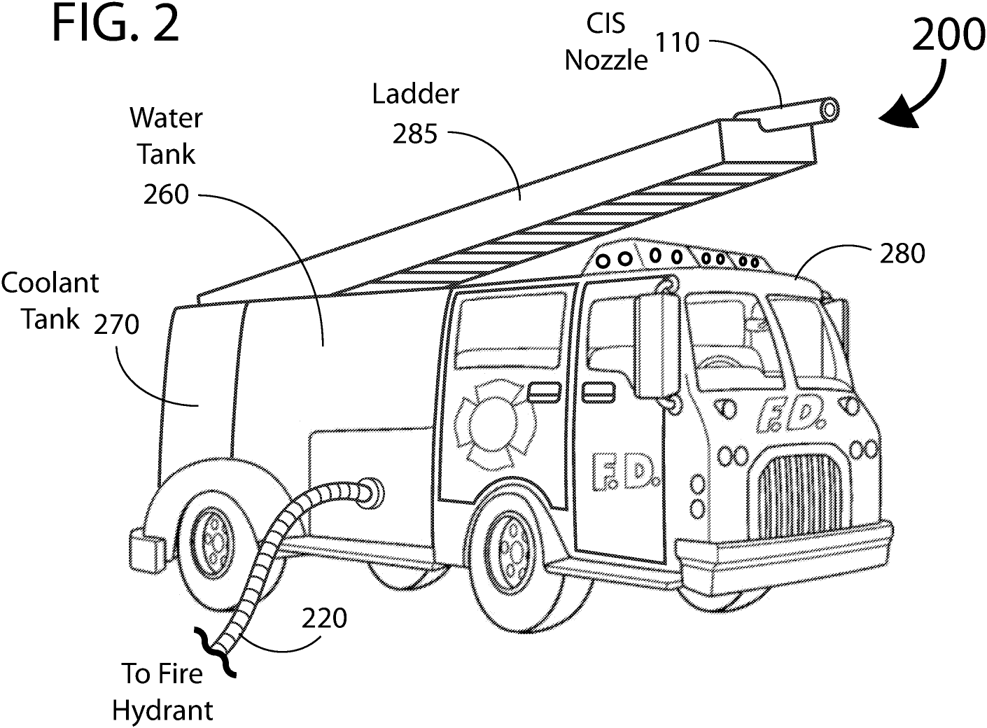

Many modifications, additions and/or deployment models, such as vehicular-based and aircraft-based deployment platforms, are possible. For example, FIG. 2 is a perspective view illustrating an exemplary deployment of a vehicular-based embodiment 200 that includes the Coolant Infusion Spray Nozzle (“CISN”) 110 depicted by FIGS. 4A-C. This exemplary embodiment 200 includes a fire truck 280 providing a platform for an extendable ladder 285, a water tank 260, a coolant tank 270, and the CISN 110. For extended operations, a water hose 220 enables the fire truck 280 to be resupplied by an external water source, such as a fire hydrant (not shown).

In some embodiments, the vehicular-based CISN 110 is deployed at the top of the ladder 285 so as to maximize its reach and range. CISN 110 can either be manually controlled by a firefighter (not shown) perched at the top of ladder 285 behind CISN 110. Alternatively, CISN 110 can be controlled by a local operator located inside fire truck 280 and/or remotely controlled by a remote operator located at an incident command post.

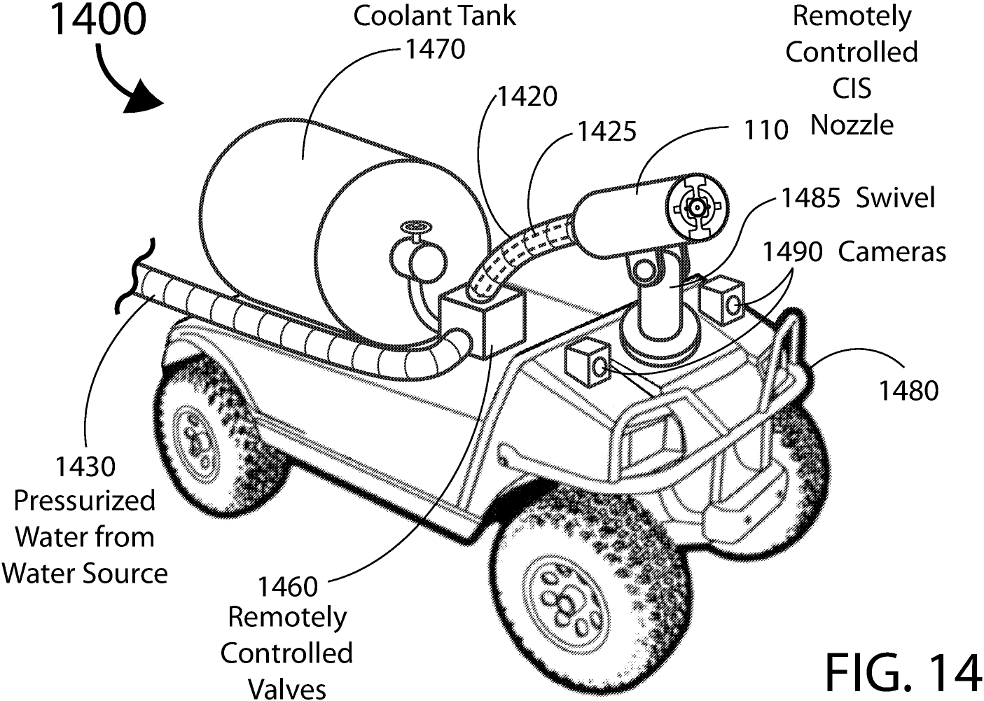

FIG. 14 is a perspective view illustrating another exemplary deployment of a vehicular-based embodiment 1400 that includes the CISN 110 depicted by FIGS. 4A-C. This exemplary embodiment 1400 includes a remotely controlled all-wheel-drive all-terrain-vehicle (“ATV”) 1480 providing a compact platform for a coolant tank 1470, remotely controlled valves 1460, and camera(s) 1490. The CISN 110 can be mounted on a remotely controlled swivel 1485.

The CISN 110 is operatively coupled to the remotely controlled valves 1460 by a water hose 1420 and a coolant 1425 located inside the water hose 1420. Because of the limited physical size and laden weight capacity of the ATV 1480, a water hose 1430 supplies water from an external water source, such as a fire hydrant (not shown) or a fire truck (not shown). Such a compact platform is advantageous, as ATV 1480 is able to navigate narrow footpaths and/or steep terrain. Furthermore, compact ATV 1480 is also capable of entering a variety of buildings such as warehouses, factories, barns and stables, while not directly endangering the firefighting operator who is able to remotely control the CISN 110 from a relatively safe distance, since it is well known that fire-damaged buildings are prone to collapse.

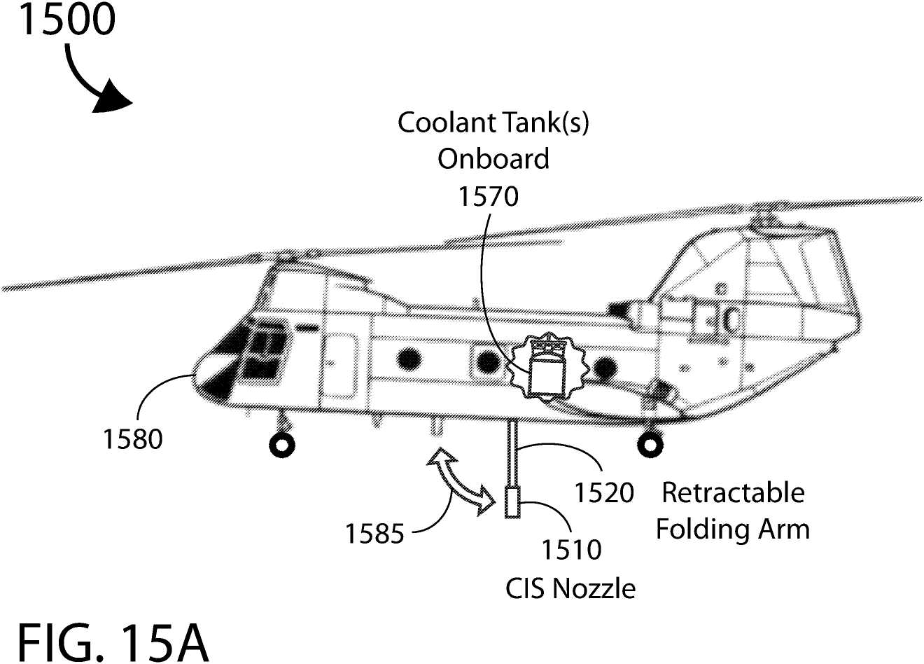

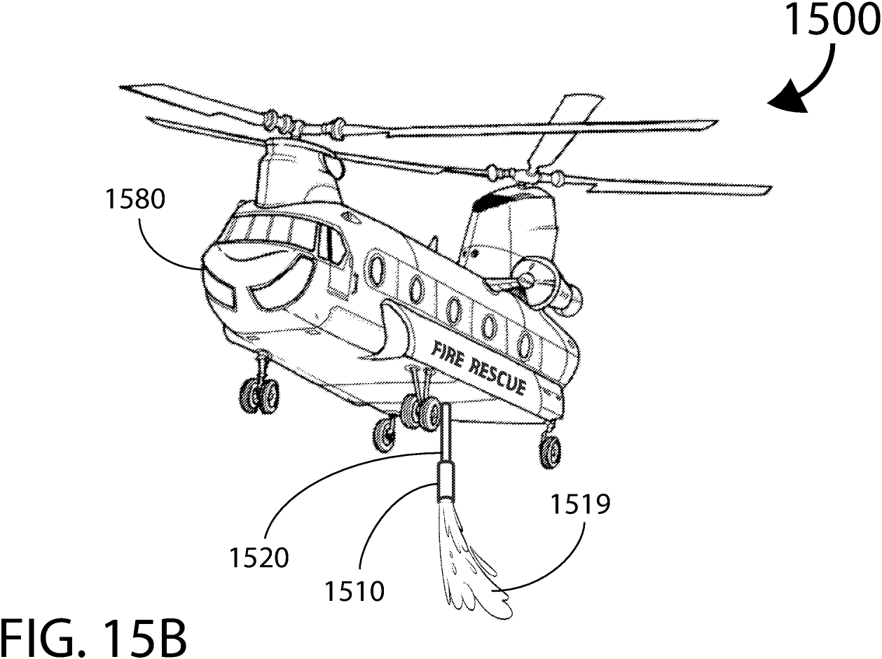

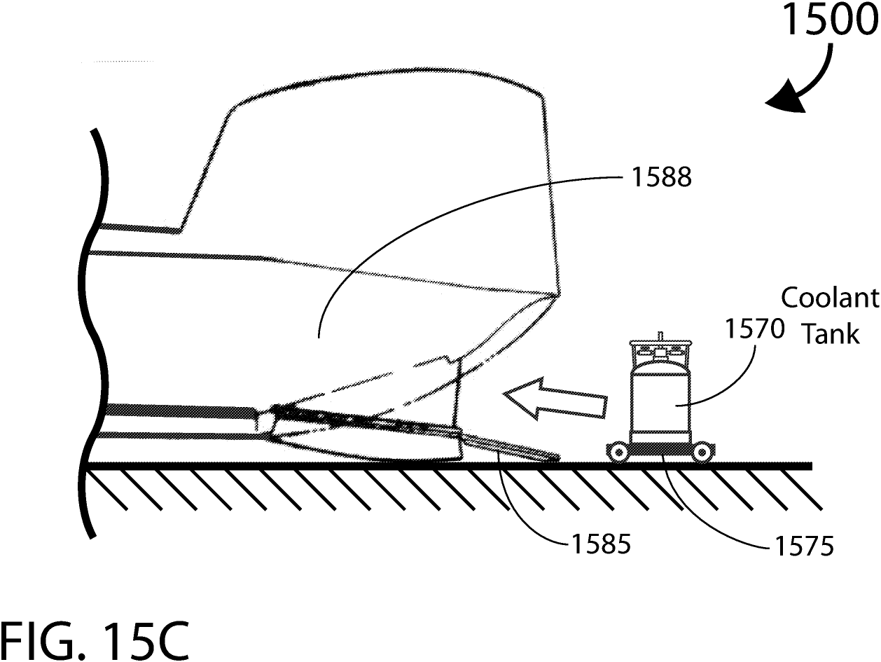

FIGS. 15A-15C are perspective and side views illustrating an exemplary deployment of an aircraft-based embodiment 1500 that includes an aerial version 1510 of the CISN 110 depicted by FIGS. 4A-C. This exemplary embodiment 1500 includes a fixed-wing aircraft 1580 such as a Chinook 47, a twin-engine, tandem rotor, heavy-lift behemoth that has a potential payload of over 20,000 pounds. A typical Chinook 47 equipped for fire-fighting is capable of carrying up to 3,000 gallons of water. In this embodiment, helicopter 1580 provides an aerial platform for one or more water tanks (not shown), one or more onboard coolant tanks 1570, and an aerial CISN 1510 mounted on a retractable arm 1520. The arm 1520 can be folded to fit horizontally under the belly of helicopter 1580 prior to deployment (see directional arrow 1585).

As shown in the side view of FIG. 15C, because the rear tandem rotor is mounted high on its airframe, amongst fixed-wing aircrafts, helicopter 1580 offers a relatively high and wide loading ramp 1585 for quickly loading coolant tank 1570 into its large interior cargo bay 1588, and subsequently quickly offloading empty coolant tank(s).

In sum, the present invention provides systems and methods for infusing a coolant into a fire suppressing water stream thereby substantially reducing the temperature of the water stream. The advantages of such a system include the ability to more rapidly suppress and/or extinguish a fire with the same volume of water.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. In addition, where claim limitations have been identified, for example, by a numeral or letter, they are not intended to imply any specific sequence.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A fire suppression system configured to provide a mixture of coolant and water, the fire suppression system comprising:
a Coolant Infusion Spray Nozzle (CISN) assembly including:
a water inlet configured to receive water from a water source suppling the water at a water pressure;
a coolant inlet configured to receive coolant from a coolant source supplying the coolant at a coolant pressure, and wherein the coolant pressure is higher than the water pressure; and
a coolant infuser configured to receive the coolant from the coolant inlet, and wherein the infuser includes at least one infusion aperture configured to infuse the coolant into the water while the water is bypassing an exterior of the coolant infuser thereby generating a pressurized mixture of coolant and water streaming out from the CISN assembly for suppressing a fire.

2. The fire suppression system of claim 1 wherein the coolant from the coolant source includes liquid nitrogen.

3. The fire suppression system of claim 1 wherein the CISN assembly further comprises an inlet cap configured to align the coolant inlet within the water inlet.

4. The fire suppression system of claim 3 wherein the inlet cap includes at least one water ejection hole configured to release the water from the water inlet destined to bypass the exterior of the coolant infuser.

5. The fire suppression system of claim 1 wherein the CISN assembly further comprises a nozzle housing configured to house the coolant infuser, and wherein the coolant is infused into the water inside a mixing chamber within the nozzle housing.

6. The fire suppression system of claim 5 wherein the CISN assembly further comprises a nozzle positioning tab configured to stabilize the coolant infuser within the nozzle housing.

7. The fire suppression system of claim 1 wherein the CISN assembly further comprises a coolant spray head with a coolant ejection hole configured to release additional coolant into the mixture of coolant and water streaming out from the CISN assembly.

8. The fire suppression system of claim 1 further comprising a Coolant Introduction Adapter configured to supply the coolant to the CISN assembly.

9. The fire suppression system of claim 8 wherein the Coolant Introduction Adapter is a Coolant Introduction Adapter Cap (CIAC) assembly configured to supply the water and the coolant to the CISN assembly, and wherein the CIAC assembly includes:
a housing having a first interface and a second interface, wherein the first interface is configured to operatively couple the CIAC assembly to a water source, and wherein the second interface is configured to operatively couple the CIAC assembly to the CISN assembly; and
a coolant elbow configured to direct the coolant from the coolant source toward the CISN assembly.

10. The fire suppression system of claim 9 further comprising a water hose and a coolant hose, wherein the coolant hose is configured to be located inside the water hose, wherein the water hose is configured to relay the water from the CIAC assembly to the CISN assembly, and wherein the coolant hose is configured to relay the coolant from the CIAC assembly to the CISN assembly.
